(19) United States
(12) Patent Application Publication
(10) Pub. No.: US 2025/0148761 A1
(43) Pub. Date: May 8, 2025

(54) APPARATUS AND METHOD FOR 3D DYNAMIC SPARSE CONVOLUTION

(71) Applicant: Intel Corporation, Santa Clara, CA (US)

(72) Inventors: Dongqi CAI, Beijing (CN); Anbang YAO, Beijing (CN); Chao LI, Beijing (CN); Shandong WANG, Beijing (CN); Yurong CHEN, Beijing (CN)

(21) Appl. No.: 18/717,894

(22) PCT Filed: Mar. 3, 2022
(86) PCT No.: PCT/CN2022/078939

§ 371 Date: Jun. 7, 2024

(51) Int. Cl. G06V 10/771; G06T 5/20; G06V 10/40; G06V 20/64

(52) U.S. Cl. CPC G06V 10/771; G06T 5/20; G06V 10/513; G06V 20/64

(57) ABSTRACT

The disclosure provides an apparatus, method, device and medium for 3D dynamic sparse convolution. The method includes: receiving an input feature map of a 3D data sample; performing input feature map partition to divide the input feature map into a plurality of disjoint input feature map groups; performing a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and performing output feature map grouping to sequentially stack the plurality of output feature maps to obtain an output feature map corresponding to the input feature map. (FIG. 2).

### TECHNICAL FIELD

Embodiments of the present disclosure generally relate to techniques of convolutional neural networks (CNNs), and in particular to an apparatus and a method for 3-dimensional (3D) Dynamic Sparse Convolution.

### BACKGROUND ART

With the rapid development of low-cost data acquisition devices and cameras (e.g., Microsoft Kinect and Intel RealSense), 3D visual recognition such as 3D object detection and semantic scene completion have become more and more important for many emerging applications such as autonomous driving, robotics, AR/VR and SLAM. Due to the popularity of deep learning, 3D CNNs are becoming the mainstream solutions for 3D visual recognition tasks. However, in sharp contrast to conventional 2D CNNs, 3D CNNs have one additional spatial dimension (i.e., depth/point cloud with much larger channel resolution in comparison to RGB, for example 512 vs. 3) regarding the mathematical operations, posing the problem of the cubic growth for the computation and memory requirements.

### SUMMARY

According to an aspect of the disclosure, a method is provided. The method includes: receiving an input feature map of a 3-dimensional (3D) data sample; performing input feature map partition to divide the input feature map into a plurality of disjoint input feature map groups; performing a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and performing output feature map grouping to sequentially stack the plurality of output feature maps to obtain an output feature map corresponding to the input feature map.

According to another aspect of the disclosure, an apparatus is provided. The apparatus includes: interface circuitry; and processor circuitry coupled to the interface circuitry and configured to: receive an input feature map of a 3-dimensional (3D) data sample; perform input feature map partition to divide the input feature map into a plurality of disjoint input feature map groups; perform a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and perform output feature map grouping to sequentially stack the plurality of output feature maps to obtain an output feature map corresponding to the input feature map.

Another aspect of the disclosure provides a device including means for implementing the method of the disclosure.

Another aspect of the disclosure provides a machine readable storage medium having instructions stored thereon, which when executed by a machine cause the machine to perform the method of the disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an exemplary illustration of an exemplary visual comparison between regular dense 3D convolution and conventional sparse 3D convolution.

FIG. 2 is a block diagram illustrating 3D Dynamic Sparse Convolution (3DSC) in accordance with some embodiments of the disclosure.

FIG. 3 is a block diagram illustrating an exemplary multi-dimensional attention (MDA) block in accordance with some embodiments of the disclosure.

FIG. 4 is an exemplary illustration of 3DSC with an instantiation of MDA block in accordance with some embodiments of the disclosure.

FIG. 5 illustrates visualization comparisons for semantic scene completion with 3DSC and S3GC in accordance with some embodiments of the disclosure.

FIG. 6 illustrates a flow chart illustrating an exemplary method 600 for 3DSC in accordance with some embodiments of the disclosure.

FIG. 7 is a block diagram illustrating components, according to some example embodiments, able to read instructions from a machine-readable or computer-readable medium and perform any one or more of the methodologies discussed herein.

FIG. 8 is a block diagram of an example processor platform in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment”, “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

To address the computational problems associated with 3D CNNs, various techniques have been proposed. However, they mainly focus on network architecture designing based on the direct use of conventional sparse 3D convolutions, paying no effort on designing much more efficient sparse 3D convolutions or improving the efficiency of conventional sparse 3D convolutions.

In order to efficiently address the computational problem of 3D CNNs, the present disclosure provides a leading technique called 3D Dynamic Sparse Convolution (3DSC), which can linearly reduce the computational cost meanwhile can also significantly boost the performance of the conventional sparse 3D CNNs with negligible extra parameters, opening a new direction for designing much more efficient sparse 3D CNNs.

3DSC targets to develop an optimal sparse 3D convolution. To this goal, firstly, 3DSC has three interdependent operations to encourage the full use of sparsity, namely input feature map partition (into disjoint groups with linearly increased sparse ratios), shared 3D dynamic sparse convolutions (to all disjoint groups) and output feature map grouping (from applying shared 3D dynamic sparse convolutions over all disjoint groups). Secondly, 3DSC introduces dynamic mechanism to generate the shared 3D dynamic sparse convolution kernels, making the convolutional kernels be sample-adaptive. Thirdly, 3DSC inserts a multi-dimensional attention mechanism for modulating the shared 3D dynamic sparse convolution kernels, providing a performance guarantee to capture rich context cues, and striking the best tradeoff of model size and accuracy.

Benefiting from these novel mechanisms, 3DSC forms a generic modular 3D dynamic sparse convolution design, which can accelerate sparse 3D convolutions with significantly improved performance at the cost of negligible extra parameters in a plug and play manner.

Before discussion the details of various embodiments, it's helpful to begin with the basic concepts of regular dense 3D convolution and conventional sparse 3D convolution. Given a 3D convolutional layer, let X∈ [symbol] ^{W×H×D×M} be the input feature map, f∈ [symbol] ^{K}^{_{W}}^{×K}^{_{H}}^{×K}^{_{D}}^{×M×N} be the convolutional kernels, Y∈ [symbol] ^{W×H×D×N} be the output feature map, where W/H/D is the spatial size of 3D data/input feature map, M/N is the number of input/output feature map channels, K_{W}×K_{H}×K_{D} is the spatial kernel size (it can be also set to K_{W}×K_{H} for 2D case). For simplicity, the input and the output are assumed to have the same spatial size (which can be different when convolution stride is larger than 1).

For regular dense 3D convolution, f is applied on every feature location of X. In contrast, for conventional sparse 3D convolution, f is only applied on active/valid (i.e., non-zero/non-empty) feature locations (e.g., stored with a hash table) of X. Comparatively, if the sparsity ratio of the input feature map is s %, the computational cost can be reduced to s % using the conventional sparse 3D convolution. For simplicity, the conventional sparse 3D convolution may be demoted as:

$$Y = X * f \qquad ( 1 )$$

where “*” denotes the sparse 3D convolution operation and f is the conventional sparse 3D convolutional kernels. It should be noted that the convolutional kernels f here are static, which means they are fixed and applied to all active/valid feature locations at a convolutional layer.

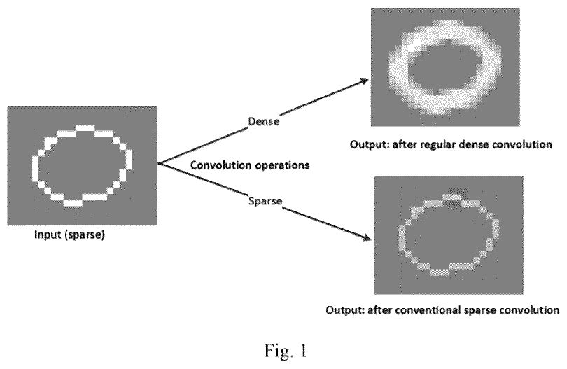

FIG. 1 is an exemplary illustration of an exemplary visual comparison between regular dense 3D convolution and conventional sparse 3D convolution. Here a 3×3 convolution is used for 2D visualization only. As shown in FIG. 1, unlike regular dense 3D convolution, the input and the output of conventional sparse 3D convolution have the same sparse structures.

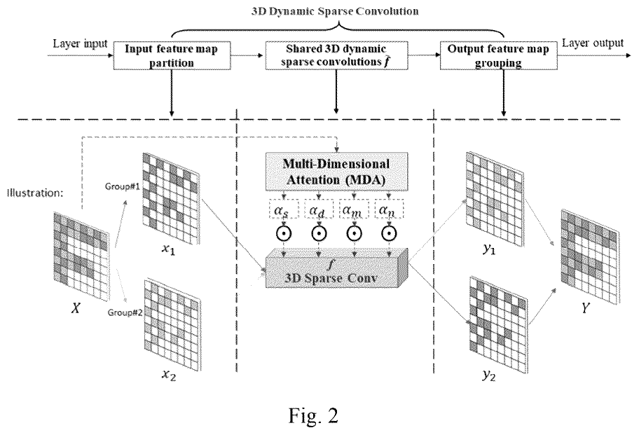

To encourage the full use of sparsity, 3DSC is provided in the present disclosure. FIG. 2 is a block diagram illustrating 3DSC in accordance with some embodiments of the disclosure. As shown in FIG. 2, 3DSC may have three interdependent operations: (1) input feature map partition; (2) shared 3D dynamic sparse convolution; (3) output feature map grouping. First, with input feature map partition, S3GC may divide an input feature map X into G disjoint groups {xᵢ}ᵢ₌₁^{G}, here 1<G<K_{W}×K_{H}×K_{D}, wherein G is the number of groups and each group has a linear increased sparse ratio. As a result, the sparse ratio of each input feature map group xᵢ is increased to G times of its original ratio in average. Second, with a shared 3D dynamic sparse convolution, S3GC enjoys the increased sparse property of data (e.g., point cloud data)/input feature map groups by applying the shared 3D dynamic sparse convolution to all the disjoint groups. Third, with output feature map grouping, S3GC gets enhanced feature representation Y by sequentially stacking output feature maps {yᵢ}ᵢ₌₁^{G} from performing the shared 3D dynamic sparse convolution over all different input feature map groups. Therefore, 3Dsc can be denoted as:

$${\{ {y}_{i} \}}_{i = 1}^{G} = {\{ {x}_{i} \}}_{i = 1}^{G} * \tilde{f} \qquad ( 2 )$$

where \tilde{f} is the shared 3D dynamic sparse convolutional kernel.

In some embodiments, the shared 3D dynamic sparse convolutional kernel \tilde{f} may be generated by a dynamic and multi-dimensional attention mechanisms. In an embodiment, \tilde{f} may be dynamically generated through sequentially multiplying a 3D static sparse convolution kernel with at least one of four attentive scalars along all four different dimensions of kernel space, wherein the four dimensions are spatial, depth, numbers of input and output channels. In an example, as shown in FIG. 2, \tilde{f} is dynamically generated through sequentially multiplying with all the four attentive scalars:

$$\tilde{f} = f ⊙ {α}_{s} ⊙ {α}_{d} ⊙ {α}_{m} ⊙ {α}_{n} \qquad ( 3 )$$

where “⊙” denotes element-wise multiplication operations, and αₛ, α_{d}, αₘ and αₙ represent the attentive convolutional kernel scalars along the spatial dimension, the depth dimension, the input channel number dimension and the output channel number dimension of convolutional kernel space, respectively.

In some embodiments, the at least one attentive scalars may be dynamically generated based on the input feature map. In some embodiments, the shared 3D dynamic sparse convolutional kernel may be obtained by sequentially multiplying the generated attentive scalars with the 3D static sparse convolution kernel in an element-wise product way.

Through sequentially multiplying with at least one attentive scalars along different dimensions, the capability of the shared dynamic 3D sparse convolution kernel for modeling input data/features is augmented with flexible adaptiveness.

In some embodiments, these attentive scalars αₛ, α_{d}, αₘ and αₙ may be dynamically generated by performing a spatial aggregation operation on the input feature map to produce a channel descriptor, performing a channel squeeze and excitation operation to transform the channel descriptor for further abstraction, and performing a mapping and scaling operation to map and scale the abstracted descriptor to the sizes of different dimensions of the 3D convolution kernel space and output the corresponding attentive scalars respectively.

In some embodiments, these attentive scalars αₛ, α_{d}, αₘ and αₙ may be dynamically generated by a novel lightweight multi-dimensional attention (MDA) block conditioned on the input feature map X:

$$[ {α}_{s} , {α}_{d} , {α}_{m} , {α}_{n} ] = MDA ( X ) \qquad ( 4 )$$

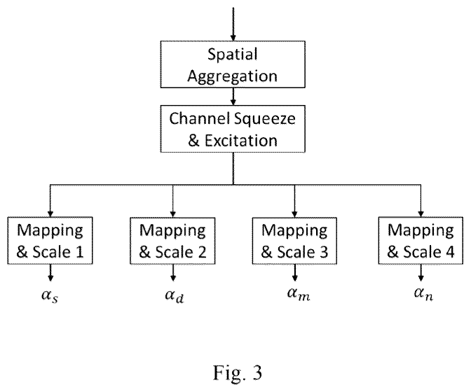

FIG. 3 is a block diagram illustrating an exemplary MDA block in accordance with some embodiments of the disclosure. The MDA block is a lightweight structure designed for computing attentive kernel scalars along all four dimensions of the sparse 3D convolution kernel space. As illustrated in FIG. 3, the MDA block may be configured to perform a spatial aggregation operation on the input feature map to produce a channel descriptor, perform a channel squeeze and excitation operation to transform the channel descriptor for further abstraction, and perform a mapping and scaling operation to map and scale the abstracted descriptor to the sizes of different dimensions of the 3D convolution kernel space and output the corresponding attentive scalars respectively.

In some embodiments, the spatial aggregation operation may be performed with a Pooling function, which may be Global Average Pooling, Max Pooling, Random Pooling, Min Pooling, etc., which is not limited herein.

In some embodiments, the channel squeeze and excitation operation may be performed by adopting a fully connected layer or 1×1 convolution layer with a channel squeeze ratio r followed by normalization and non-linear activation. In some embodiments, the normalization may be Batch Normalization, Group Normalization, Instance Normalization, etc., which is not limited herein.

In some embodiments, the mapping and scaling operation may be performed using an operation of fully connected layer or 1×1 convolution layer, and an operation of non-linear activation.

In some embodiments, the non-linear activation may be performed with ReLU, Softmax, Sigmoid, Tanh, etc., which is not limited herein.

In an example, the MDA block may first aggregate the input feature maps across spatial dimensions to produce a channel descriptor. This descriptor well embeds the global distribution of channel-wise feature responses. A channel squeeze/excitation operation is followed to transform the channel descriptor for further abstraction. Four mapping and scaling units map and scale the abstraction descriptor to the sizes of different dimensions of convolution kernel space and output four corresponding attentive kernel scalars respectively. As denoted in Eq. (3), these scalars are then sequentially multiplied with the originally static convolution kernels in an element-wise product way to obtain the dynamic kernel of 3DSC.

In some embodiments, in 3DSC, the input feature map partition may be performed along feature locations, i.e., based on 3D coordinates of features, and different groups may be stacked along the batch dimension. For original sparse input feature map whose size is B×W×H×D×M (batch-size×width×height×depth×channel), after the input feature map partition operation, it becomes (G×B)×W×H×D×M, where G is the number of group. Similar to the conventional sparse 3D convolutions, hash table based representation may also be used, thus only active/valid voxels are stored. In the hash table, just one more index value for each active/valid voxel is added, indicating its group ID. The memory cost of this operation is negligible.

In each 3D convolutional computation with kernel size K×K×K, only part of original active/valid voxels in its receptive field participates in the calculation, and the number of valid voxels in each group is about 1/G of the original non-empty voxels after partition. Therefore, the final computation cost is about (N×K³/G)/(N×K³), which is 1/G of original sparse 3D convolutions when ignoring the bias computation, where N is the total number of valid voxels, and K³ is the 3D convolutional kernel size. Therefore, 3DSC linearly reduces the computational cost to 1/G of the conventional sparse 3D convolutions, here 1<G<K³. The larger the group number, the higher the computation reduction.

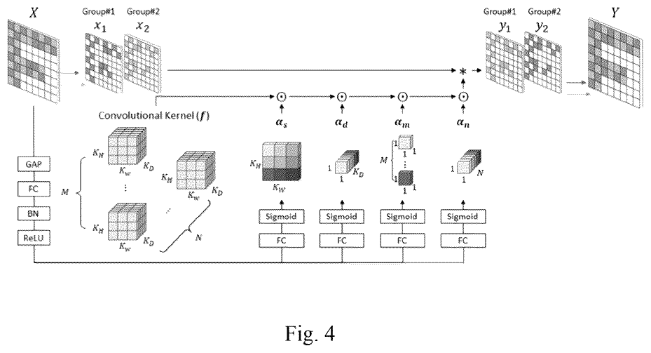

FIG. 4 is an exemplary illustration of 3DSC with an instantiation of MDA block in accordance with some embodiments of the disclosure. Considering the efficiency of the shared 3D dynamic sparse convolution, an instantiation as shown in FIG. 4 may be used as an example use case.

As shown in FIG. 4, a global average pooling (GAP) operation may be used to conduct spatial aggregation of input feature maps. In some embodiments, the pooling operation may be performed with any pooling operation, such as Max Pooling, Random Pooling, Min Pooling, etc., which is not limited herein. A fully connected (FC) layer with channel squeeze ratio r followed by normalization (BN) and non-linear activation (e.g., ReLU) is adopted to transform the channel descriptor for further abstraction. The abstracted descriptor is further mapped and scaled to be the attentive scalars respectively using, for example, FC and Sigmoid operations. In this case, the extra parameters of 3DSC compared to conventional sparse 3D convolution can be denoted as

$$m \times \frac{m}{r} + \frac{m}{r} \times ( s + d + m + n ) ,$$

where s, d, m and n represent the spatial size, the depth size, the number of input channel, and the number of output channel, respectively, and r represents the squeeze ratio. When using squeeze ratio r=4 and taking s=3×3=9, d=9 and m=n=256, the number of extra parameters to a single conventional static sparse 3D convolution introduced by 3DSC is less than 1% of the original static kernel (s×d×m×n), which is quite a lightweight design.

Extensive experiments on the large-scale SUNCG dataset for indoor semantic scene completion task are conducted. Popular SSCNet and Sparse 3D Group Convolution (S3GC) with a static convolution kernel are used as two test case baselines. Tables 1-3 summarize the detailed result comparisons. Table 1 shows Intersection over Union (IoU) (%) comparison on the large scale SUNCG dataset. Table 2 shows floating point operations per second (FLOPs) reduction and IoU accuracy of 3DSC with different group numbers. Table 3 shows complementarity study of four types of attentive convolutional kernel scalars of 3DSC.

TABLE 1
IoU (%) comparison on the large scale SUNCG dataset.

| | | IoU |
|---|---|---|
| | IoU | (Semantic Scene |
| Method | (Scene Completion, %) | Completion, %) |
| SSCNet | 73.5 | 46.4 |
| S3GC w/4 Groups | 84.0 | 69.6 |
| 3DSC w/4 Groups | 91.1 | 77.6 |

TABLE 2
FLOPs reduction and IoU accuracy of
3DSC with different group numbers.

| Group Number | FLOPs (G) | IoU (Scene Completion, %) |
|---|---|---|
| 1 | 80.1 | 92.5 |
| 2 | 40.2 | 92.1 |
| 3 | 28.3 | 91.6 |
| 4 | 21.2 | 91.1 |
| 5 | 20.0 | 90.3 |
| 6 | 18.9 | 89.6 |

TABLE 3
Complementarity study of four types of attentive
convolutional kernel scalars of 3DSC.

| | | | | | IoU | IoU |
|---|---|---|---|---|---|---|
| | | | | | (Scene | (Semantic |
| Method | αₛ | α_{d} | αₘ | αₙ | Completion) | Scene Completion) |
| SSCNet [10] | — | — | — | — | 73.5 | 46.4 |
| Our 3DSC | ✓ | — | — | — | 86.3 | 73.2 |
| (r = ¼) | ✓ | ✓ | — | — | 87.6 | 74.6 |
| | ✓ | ✓ | ✓ | — | 89.8 | 75.9 |
| | ✓ | ✓ | ✓ | ✓ | 91.1 | 77.6 |

From the results in Tables 1-3, it can be clearly seen by applying 3DSC to S3GC, that 4×FLOPs reduction with more than 6% IoU improvements can be further obtained with less than 1% extra parameters.

As can be clearly seen from the results shown in Tables 1-3, 4×FLOPs reduction with more than 6% accuracy gain at the cost of less than 1% extra parameters on the large scale SUNCG dataset can be achieved for 3D semantic scene completion tasks, when comparing 3DSC to conventional 3D sparse convolution and other state-of-the-art 3D sparse convolutions.

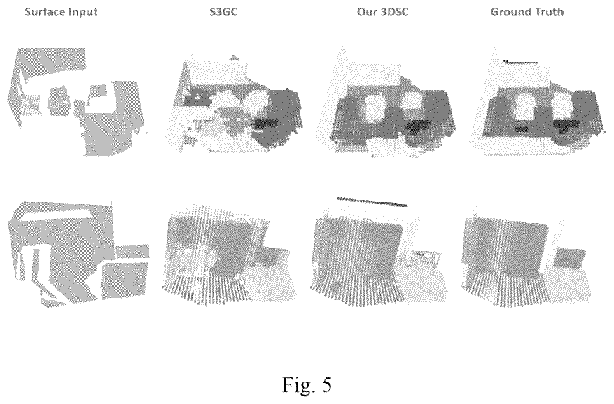

FIG. 5 illustrates visualization comparisons for semantic scene completion with 3DSC and S3GC, which shows some illustrative results for semantic scene completion, e.g., performing both geometric structure recovery and voxel-wise recognition. As shown in FIG. 5, 3DSC has much better accuracy than S3GC, which is significantly closer to ground truth.

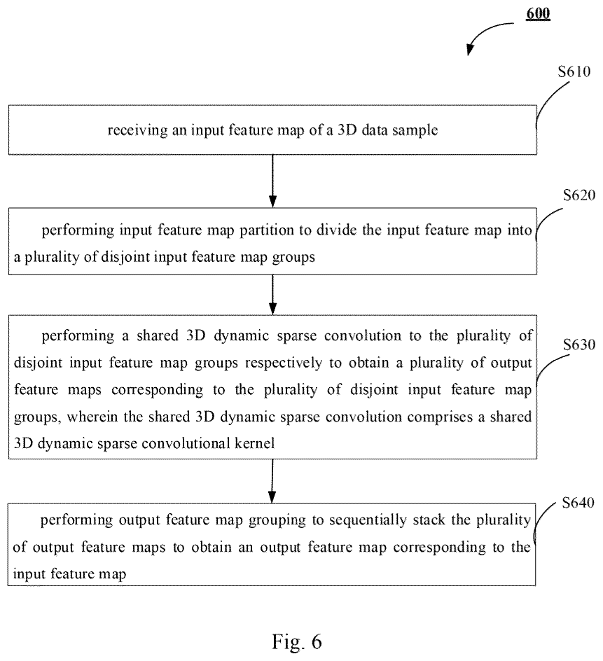

FIG. 6 illustrates a flow chart illustrating an exemplary method 600 for 3D dynamic sparse convolution in accordance with some embodiments of the disclosure. The method 600 may include blocks S610-S640.

At block 610, receiving an input feature map of a 3D data sample. In some embodiments, the 3D data may be point cloud data. At block 620, performing input feature map partition to divide the input feature map into a plurality of disjoint input feature map groups. At block 630, performing a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and At block 640, performing output feature map grouping to sequentially stack the plurality of output feature maps to obtain an output feature map corresponding to the input feature map.

In some embodiments, the method 600 may include more or less steps. The disclosure is not limited in this aspect. Also, the method 600 may be understood in conjunction with the embodiments described above.

The present disclosure provides a generic modular 3D dynamic sparse convolution design for much more efficient sparse 3D CNNs. 3DSC can be used in any kind of existing/emerging deep learning tools/frameworks such as Caffe, Tensorflow, Pytorch and MxNet. By using three interdependent operations (including input feature map partition, shared 3D dynamic sparse convolutions and output feature map grouping), a dynamic mechanism to generate the shared 3D dynamic sparse convolution kernels), and a multi-dimensional mechanism to modulate the dynamically generated convolution kernels, 3DSC can linearly reduce the computational cost meanwhile can also significantly boost the performance of the conventional sparse 3D CNNs with negligible extra parameters in a plug and play manner, opening a new direction for designing much more efficient sparse 3D CNNs.

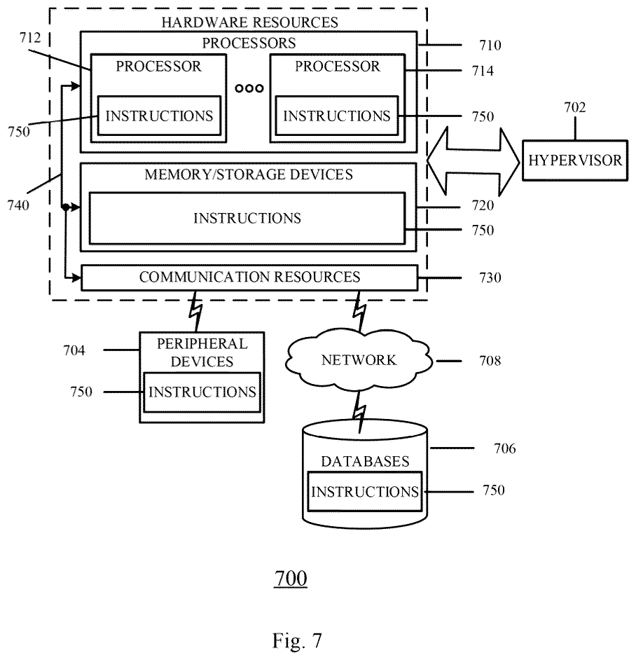

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714 which may be, e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

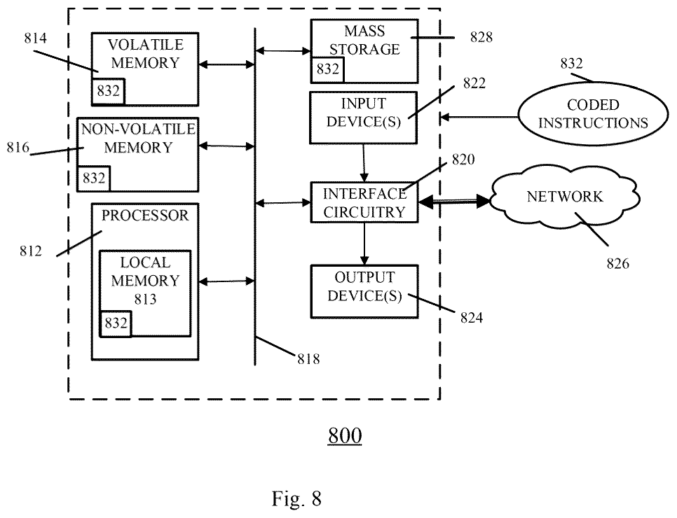

FIG. 8 is a block diagram of an example processor platform in accordance with some embodiments of the disclosure. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes interface circuitry 820. The interface circuitry 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuitry 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 820 of the illustrated example, thus, typically includes a graphics driver card, a graphics driver chip and/or a graphics driver processor.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 820 may include a training dataset inputted through the input device(s) 822 or retrieved from the network 826.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives. Machine executable instructions 832 may be stored in the mass storage device 828, in the volatile memory 814, in the non-volatile memory 816, and/or on a removable non-transitory computer readable storage medium such as a CD or DVD

The following paragraphs describe examples of various embodiments.

Example 1 includes a method for 3-dimensional (3D) dynamic sparse convolution, comprising: receiving an input feature map of a 3D data sample; performing input feature map partition to divide the input feature map into a plurality of disjoint input feature map groups; performing a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and performing output feature map grouping to sequentially stack the plurality of output feature maps to obtain an output feature map corresponding to the input feature map.

Example 2 includes the method of Example 1, wherein the shared 3D dynamic sparse convolutional kernel is modulated with a multi-dimensional mechanism.

Example 3 includes the method of Example 1 or 2, further comprising: dynamically generating the shared 3D dynamic sparse convolutional kernel by sequentially multiplying a 3D static sparse convolution kernel with at least one of four attentive scalars along four dimensions of a 3D convolution kernel space, wherein the four dimensions comprising a spatial size, a depth size, an input channel number, and an output channel number.

Example 4 includes the method of any one Examples 1-3, wherein the four attentive scalars are generated by a multi-dimensional attention block.

Example 5 includes the method of any one Examples 1-4, further comprising: dynamically generating the at least one attentive scalars based on the input feature map; and sequentially multiplying the generated attentive scalars with the 3D static sparse convolution kernel in an element-wise product way to obtain the shared 3D dynamic sparse convolutional kernel.

Example 6 includes the method of any one Examples 1-5, further comprising: performing a spatial aggregation operation on the input feature map to produce a channel descriptor; performing a channel squeeze and excitation operation to transform the channel descriptor for further abstraction; and performing a mapping and scaling operation to map and scale the abstracted descriptor to the sizes of different dimensions of the 3D convolution kernel space and output the corresponding attentive scalars respectively.

Example 7 includes the method of any one Examples 1-6, wherein spatial aggregation operation is performed with a Pooling function.

Example 8 includes the method of any one Examples 1-7, wherein the Pooling function comprises at least one of Global Average Pooling, Max Pooling, Random Pooling or Min Pooling.

Example 9 includes the method of any one Examples 1-8, wherein the channel squeeze and excitation operation is performed by adopting a fully connected layer or 1×1 convolution layer with a channel squeeze ratio r followed by normalization and non-linear activation.

Example 10 includes the method of any one Examples 1-9, wherein the normalization comprises at least one of Batch Normalization, Group Normalization, Instance Normalization.

Example 11 includes the method of any one Examples 1-10, wherein the mapping and scaling operation is performed using an operation of fully connected layer or 1×1 convolution layer, and an operation of non-linear activation.

Example 12 includes the method of any one Examples 1-11, wherein the non-linear activation is performed with at least one of ReLU, Softmax, Sigmoid, Tanh.

Example 13 includes the method of any one Examples 1-12, the input feature map partition is performed based on the feature locations.

Example 14 includes an apparatus for 3-dimensional (3D) dynamic sparse convolution, comprising: interface circuitry; and processor circuitry coupled to the interface circuitry and configured to: receive an input feature map of a 3D data sample; perform input feature map partition to divide the input feature map into a plurality of disjoint input feature map groups; perform a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and perform output feature map grouping to sequentially stack the plurality of output feature maps to obtain an output feature map corresponding to the input feature map.

Example 15 includes the apparatus of Example 14, wherein the shared 3D dynamic sparse convolutional kernel is modulated with a multi-dimensional mechanism.

Example 16 includes the apparatus of Example 14 or 15, wherein the processing circuitry is further to: dynamically generate the shared 3D dynamic sparse convolutional kernel by sequentially multiplying a 3D static sparse convolution kernel with at least one of four attentive scalars along four dimensions of a 3D convolution kernel space, wherein the four dimensions comprising a spatial size, a depth size, an input channel number, and an output channel number.

Example 17 includes the apparatus of any one Examples 14-16, wherein the four attentive scalars are generated by a multi-dimensional attention block.

Example 18 includes the apparatus of any one Examples 14-17, wherein the processing circuitry is further to: dynamically generate the at least one attentive scalars based on the input feature map; and sequentially multiply the generated attentive scalars with the 3D static sparse convolution kernel in an element-wise product way to obtain the shared 3D dynamic sparse convolutional kernel.

Example 19 includes the apparatus of any one Examples 14-18, wherein the processing circuitry is further to: perform a spatial aggregation operation on the input feature map to produce a channel descriptor; perform a channel squeeze and excitation operation to transform the channel descriptor for further abstraction; and perform a mapping and scaling operation to map and scale the abstracted descriptor to the sizes of different dimensions of the 3D convolution kernel space and output the corresponding attentive scalars respectively.

Example 20 includes the apparatus of any one Examples 14-19, wherein spatial aggregation operation is performed with a Pooling function.

Example 21 includes the apparatus of any one Examples 14-20, wherein the Pooling function comprises at least one of Global Average Pooling, Max Pooling, Random Pooling or Min Pooling.

Example 22 includes the apparatus of any one Examples 14-21, wherein the channel squeeze and excitation operation is performed by adopting a fully connected layer or 1×1 convolution layer with a channel squeeze ratio r followed by normalization and non-linear activation.

Example 23 includes the apparatus of any one Examples 14-22, wherein the normalization comprises at least one of Batch Normalization, Group Normalization, Instance Normalization.

Example 24 includes the apparatus of any one Examples 14-23, wherein the mapping and scaling operation is performed using an operation of fully connected layer or 1×1 convolution layer, and an operation of non-linear activation.

Example 25 includes the apparatus of any one Examples 14-24, wherein the non-linear activation is performed with at least one of ReLU, Softmax, Sigmoid, Tanh.

Example 26 includes the apparatus of any one Examples 14-25, the input feature map partition is performed based on the feature locations.

Example 27 includes a computer-readable medium having instructions stored thereon, wherein the instructions, when executed by processor circuitry, cause the processor circuitry to perform a method for 3D dynamic sparse convolution, the method comprising: receiving an input feature map of a 3-dimensional (3D) data sample; performing input feature map partition to divide the input feature map into a plurality of disjoint input feature map groups; performing a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and performing output feature map grouping to sequentially stack the plurality of output feature maps to obtain an output feature map corresponding to the input feature map.

Example 28 includes the computer-readable medium of Example 27, wherein the shared 3D dynamic sparse convolutional kernel is modulated with a multi-dimensional mechanism.

Example 29 includes the computer-readable medium of Example 27 or 28, further comprising: dynamically generating the shared 3D dynamic sparse convolutional kernel by sequentially multiplying a 3D static sparse convolution kernel with at least one of four attentive scalars along four dimensions of a 3D convolution kernel space, wherein the four dimensions comprising a spatial size, a depth size, an input channel number, and an output channel number.

Example 30 includes the computer-readable medium of any one Examples 27-29, wherein the four attentive scalars are generated by a multi-dimensional attention block.

Example 31 includes the computer-readable medium of any one Examples 27-30, further comprising: dynamically generating the at least one attentive scalars based on the input feature map; and sequentially multiplying the generated attentive scalars with the 3D static sparse convolution kernel in an element-wise product way to obtain the shared 3D dynamic sparse convolutional kernel.

Example 32 includes the computer-readable medium of any one Examples 27-31, further comprising: performing a spatial aggregation operation on the input feature map to produce a channel descriptor; performing a channel squeeze and excitation operation to transform the channel descriptor for further abstraction; and performing a mapping and scaling operation to map and scale the abstracted descriptor to the sizes of different dimensions of the 3D convolution kernel space and output the corresponding attentive scalars respectively.

Example 33 includes the computer-readable medium of any one Examples 27-32, wherein spatial aggregation operation is performed with a Pooling function.

Example 34 includes the computer-readable medium of any one Examples 27-33, wherein the Pooling function comprises at least one of Global Average Pooling, Max Pooling, Random Pooling or Min Pooling.

Example 35 includes the computer-readable medium of any one Examples 27-34, wherein the channel squeeze and excitation operation is performed by adopting a fully connected layer or 1×1 convolution layer with a channel squeeze ratio r followed by normalization and non-linear activation.

Example 36 includes the computer-readable medium of any one Examples 27-35, wherein the normalization comprises at least one of Batch Normalization, Group Normalization, Instance Normalization.

Example 37 includes the computer-readable medium of any one Examples 27-36, wherein the mapping and scaling operation is performed using an operation of fully connected layer or 1×1 convolution layer, and an operation of non-linear activation.

Example 38 includes the computer-readable medium of any one Examples 27-37, wherein the non-linear activation is performed with at least one of ReLU, Softmax, Sigmoid, Tanh.

Example 39 includes the computer-readable medium of any one Examples 27-38, the input feature map partition is performed based on the feature locations.

Example 40 includes a device for 3-dimensional (3D) dynamic sparse convolution, comprising: means for receiving an input feature map of a 3D data sample; means for performing input feature map partition to divide the input feature map into a plurality of disjoint input feature map groups; means for performing a shared 3D dynamic sparse convolution to the plurality of disjoint input feature map groups respectively to obtain a plurality of output feature maps corresponding to the plurality of disjoint input feature map groups, wherein the shared 3D dynamic sparse convolution comprises a shared 3D dynamic sparse convolutional kernel; and means for performing output feature map grouping to sequentially stack the plurality of output feature maps to obtain an output feature map corresponding to the input feature map.

Example 41 includes the device of Example 40, wherein the shared 3D dynamic sparse convolutional kernel is modulated with a multi-dimensional mechanism.

Example 42 includes the device of Example 40 or 41, further comprising: means for dynamically generating the shared 3D dynamic sparse convolutional kernel by sequentially multiplying a 3D static sparse convolution kernel with at least one of four attentive scalars along four dimensions of a 3D convolution kernel space, wherein the four dimensions comprising a spatial size, a depth size, an input channel number, and an output channel number.

Example 43 includes the device of any one Examples 40-42, wherein the four attentive scalars are generated by a multi-dimensional attention block.

Example 44 includes the device of any one Examples 40-43, further comprising: means for dynamically generating the at least one attentive scalars based on the input feature map; and means for sequentially multiplying the generated attentive scalars with the 3D static sparse convolution kernel in an element-wise product way to obtain the shared 3D dynamic sparse convolutional kernel.

Example 45 includes the device of any one Examples 40-44, further comprising: means for performing a spatial aggregation operation on the input feature map to produce a channel descriptor; means for performing a channel squeeze and excitation operation to transform the channel descriptor for further abstraction; and means for performing a mapping and scaling operation to map and scale the abstracted descriptor to the sizes of different dimensions of the 3D convolution kernel space and output the corresponding attentive scalars respectively.

Example 46 includes the device of any one Examples 40-45, wherein spatial aggregation operation is performed with a Pooling function.

Example 47 includes the device of any one Examples 40-46, wherein the Pooling function comprises at least one of Global Average Pooling, Max Pooling, Random Pooling or Min Pooling.

Example 48 includes the device of any one Examples 40-47, wherein the channel squeeze and excitation operation is performed by adopting a fully connected layer or 1×1 convolution layer with a channel squeeze ratio r followed by normalization and non-linear activation.

Example 49 includes the device of any one Examples 40-48, wherein the normalization comprises at least one of Batch Normalization, Group Normalization, Instance Normalization.

Example 50 includes the device of any one Examples 40-49, wherein the mapping and scaling operation is performed using an operation of fully connected layer or 1×1 convolution layer, and an operation of non-linear activation.

Example 51 includes the device of any one Examples 40-50, wherein the non-linear activation is performed with at least one of ReLU, Softmax, Sigmoid, Tanh.

Example 52 includes the device of any one Examples 40-51, the input feature map partition is performed based on the feature locations.

Example 53 includes an apparatus as shown and described in the description.

Example 54 includes a method performed at an apparatus as shown and described in the description.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. The disclosure is intended to cover any adaptations or variations of the embodiments discussed herein. Therefore, it is manifestly intended that embodiments described herein be limited only by the appended claims and the equivalents thereof.

1.-13. (canceled)

14. An apparatus for 3-dimensional (3D) dynamic sparse convolution, comprising:
interface circuitry;
machine readable instructions; and
at least one processor circuit to be programmed by the machine readable instructions to:
access an input feature map of a 3D data sample;
divide the input feature map into a plurality of disjoint input feature map groups;
perform a shared 3D dynamic sparse convolution to the plurality of disjoint input feature map groups respectively to obtain a plurality of output feature maps corresponding to the plurality of disjoint input feature map groups, the shared 3D dynamic sparse convolution including a shared 3D dynamic sparse convolutional kernel; and
sequentially stack the plurality of output feature maps to obtain an output feature map corresponding to the input feature map.

15. The apparatus of claim 14, wherein the shared 3D dynamic sparse convolutional kernel is modulated with a multi-dimensional mechanism.

16. The apparatus of claim 15, wherein one or more of the at least one processor circuit is to:
dynamically generate the shared 3D dynamic sparse convolutional kernel by sequentially multiplying a 3D static sparse convolution kernel with at least one of four attentive scalars along four dimensions of a 3D convolution kernel space, the four dimensions including a spatial size, a depth size, an input channel number, and an output channel number.

17. The apparatus of claim 16, wherein the four attentive scalars are generated by a multi-dimensional attention block.

18. The apparatus of claim 16, wherein one or more of the at least one processor circuit is to:
dynamically generate the at least one of the attentive scalars based on the input feature map; and
sequentially multiply the generated at least one of the attentive scalars with the 3D static sparse convolution kernel in an element-wise product way to obtain the shared 3D dynamic sparse convolutional kernel.

19. The apparatus of claim 18, wherein one or more of the at least one processor circuit is to:
perform a spatial aggregation operation on the input feature map to produce a channel descriptor;
perform a channel squeeze and excitation operation to transform the channel descriptor for further abstraction; and
perform a mapping and scaling operation to map and scale the abstracted descriptor to the sizes of different dimensions of the 3D convolution kernel space and output the corresponding attentive scalars respectively.

20. The apparatus of claim 19, wherein one or more of the at least one processor circuit is to perform the spatial aggregation operation with a Pooling function.

21. The apparatus of claim 20, wherein the Pooling function includes at least one of Global Average Pooling, Max Pooling, Random Pooling or Min Pooling.

22. The apparatus of claim 19, wherein one or more of the at least one processor circuit is to perform the channel squeeze and excitation operation by adopting a fully connected layer or 1×1 convolution layer with a channel squeeze ratio r followed by normalization and non-linear activation.

23. The apparatus of claim 19, wherein one or more of the at least one processor circuit is to perform the mapping and scaling operation with a fully connected layer or a 1×1 convolution layer, and a non-linear activation.

24. The apparatus of claim 14, wherein one or more of the at least one processor circuit is to partition the input feature map based on the feature locations.

25. (canceled)

26. At least one memory comprising instructions to cause at least one processor circuit to:
access an input feature map of a 3D data sample;
perform input feature map partition to divide the input feature map into a plurality of disjoint input feature map groups;
perform a shared 3D dynamic sparse convolution to the plurality of disjoint input feature map groups respectively to obtain a plurality of output feature maps corresponding to the plurality of disjoint input feature map groups, the shared 3D dynamic sparse convolution including a shared 3D dynamic sparse convolutional kernel; and
perform output feature map grouping to sequentially stack the plurality of output feature maps to obtain an output feature map corresponding to the input feature map.

27. The at least one memory of claim 26, wherein the shared 3D dynamic sparse convolutional kernel is modulated with a multi-dimensional mechanism.

28. The at least one memory of claim 27, wherein the instructions cause one or more of the at least one processor circuit to:
dynamically generate the shared 3D dynamic sparse convolutional kernel by sequentially multiplying a 3D static sparse convolution kernel with at least one of four attentive scalars along four dimensions of a 3D convolution kernel space, the four dimensions including a spatial size, a depth size, an input channel number, and an output channel number.

29. The at least one memory of claim 28, wherein the instructions cause one or more of the at least one processor circuit to generate the one or more of the attentive scalars with a multi-dimensional attention block.

30. The at least one memory of claim 28, wherein the instructions cause one or more of the at least one processor circuit to:
dynamically generate the at least one or more of the attentive scalars based on the input feature map; and
sequentially multiply the generated at least one or more of the attentive scalars with the 3D static sparse convolution kernel in an element-wise product way to obtain the shared 3D dynamic sparse convolutional kernel.

31. The at least one memory of claim 30, wherein the instructions cause one or more of the at least one processor circuit to:
perform a spatial aggregation operation on the input feature map to produce a channel descriptor;
perform a channel squeeze and excitation operation to transform the channel descriptor for further abstraction; and
perform a mapping and scaling operation to map and scale the abstracted channel descriptor to the different dimensions of the 3D convolution kernel space and output corresponding ones of the one or more of the attentive scalars respectively.

32. The at least one memory of claim 31, wherein the instructions cause one or more of the at least one processor circuit to perform spatial aggregation operation with a Pooling function.

33. The at least one memory of claim 31, wherein the instructions cause one or more of the at least one processor circuit to perform the channel squeeze and excitation operation by adopting a fully connected layer or 1×1 convolution layer with a channel squeeze ratio r followed by normalization and non-linear activation.

34. The at least one memory of claim 31, wherein the instructions cause one or more of the at least one processor circuit to perform the mapping and scaling operation with a fully connected layer or 1×1 convolution layer, and a non-linear activation.
